(19) United States
(12) Patent Application Publication
(10) Pub. No.: US 2010/0085640 A1
(43) Pub. Date: Apr. 8, 2010

(54) Polarizing plate and polarizing device comprising the same

(76) Inventors: Byung Hyun Lee, Daejeon (KR); Kyung Jun Kim, Daejeon (KR)

Correspondence Address: MCKENNA LONG & ALDRIDGE LLP, 1900 K STREET, NW, WASHINGTON, DC, 20006, US

(21) Appl. No.: 12/311,352

(22) PCT Filed: Jun. 19, 2008
(86) PCT No.: PCT/KR2008/003488

§ 371 Date: Mar. 27, 2009

(30) Foreign Application Priority Data
Jun. 19, 2007 (KR) 10-2007-0059952

(51) Int. Cl. G02B 5/30

(52) U.S. Cl. 359/488

(57) ABSTRACT

Provided are a polarizing plate capable of polarizing unparallel incident light to polarized light in a high degree, and a polarizing device including the polarizing plate. The polarizing plate includes a quartz substrate including a light incidence portion continuously formed along a direction of the quartz substrate, the light incidence portion having a triangular section, the triangular section forming a sloped angle of a sloped surface or two symmetrical sloped surfaces having a real value in a range of Brewster's angle±30° (degrees). The polarizing device includes a substrate; a light source including an ultraviolet reflective part; and a polarizing plate disposed between the substrate and the light source.

### TECHNICAL FIELD

The present invention relates to a polarizing plate and a polarizing device having the same, which are capable of polarizing unparallel incident light to polarized light in a high degree, and more particularly, to a polarizing plate and a polarizing device having the same, which are capable of polarizing unparallel ultraviolet light to polarized light with high illumination.

### BACKGROUND ART

Recently, liquid crystal displays (LCD) are widely used as display devices for mobile phones, electronic calculators, laptop computers, LCD monitors, and so on.

Such an LCD includes upper and lower substrates disposed to face each other and spaced at a predetermined gap by a spacer, and a liquid crystal layer disposed between the upper substrate and the lower substrate. The upper substrate and the lower substrate have electrodes with a predetermined pattern on their opposite surfaces, and an alignment layer is disposed on the electrodes to determine a pre-tilt angle of a liquid crystal.

Generally, the alignment layer is aligned by a rubbing method or a photo-alignment method. The rubbing method is carried by coating a substrate with an alignment material such as polyimide and inducing pre-tilt of liquid crystals by means of a mechanical friction generated with a rubbing cloth. This method is widely used in the field of industrial applications because it can cover a large surface area and achieve a high-speed processing.

However, since shapes of fine grooves formed on the alignment layer are different depending on the intensity of friction, liquid crystal molecules are not aligned uniformly, causing random phase distortion and light scattering. Consequently, the performance of the LCD may be degraded. Also, the generation of dusts and static electricity in the rubbing process result in reduction of yield.

The photo-alignment method is to induce a pre-tilt of liquid crystals by irradiating ultraviolet light onto a substrate coated with an alignment layer. Unlike the rubbing method, the photo-alignment method does not result in the generation of dusts and static electricity. Also, the photo-alignment method can be used to control the pre-tilt simultaneously across the entire surface of the alignment layer and align the liquid crystal molecules uniformly, thereby preventing phase distortion and light scattering.

To perform photo-alignment on an alignment layer, linearly polarized ultraviolet light or partially polarized ultraviolet light are required. A polarizing device is used to supply the polarized light. A polarizing plate used in the photo-alignment process must be able to be used for a wide area, must be able to be used in an ultraviolet region, and must have favorable thermal resistance and durability and high light transmittance.

Furthermore, as display and information materials industries become advanced, polarized ultraviolet (UV) and visible lights are increasingly required. Especially, in the case of the alignment layer in the LCD using UV light, polarized ultraviolet light for a wide area is particularly required in a twist nematic mode or a plane switching mode in which uniform alignment is required.

In this regard, when an UV light of a high energy region is used as a polarized light, there are required materials and methods which can maintain stable polarizing characteristics over prolonged durations. In the related art, a sheet-type polarizing plate has been generally used to achieve a polarization effect by aligning a light absorption layer such as iodine on a plastic substrate in one direction. However, if the sheet-type polarizing plate is exposed to strong UV light, it will burn within a short time, which leads to the loss in polarizing characteristics. For this reason, the sheet-type polarizing plate is unsuitable.

Accordingly, as another method for irradiating a wide area with uniformly polarized UV light, there has been developed a polarizer using a Brewster's angle.

However, a conventional polarizer developed for photo-alignment in an LCD employs a separate complicated optical system to irradiate a wide area with uniformly polarized UV light through a polarization effect using a Brewster's angle, and the use of the optical system increases costs considerably. Also, a Brewster polarizer has the drawback of requiring 100% of parallel light. As a related art for realizing a large-sized polarized light, Korean Patent No. 268004 discloses a large-sized polarizing plate and a polarizing device. The large-sized polarizing plate ensures uniform illumination distribution and comprises a quartz substrate parts formed in a rectangular, triangular, or parallelogram shape by stacking at least one substrate, and a polarizer holder supporting the quartz substrate part. Also, the polarizing device includes the large-sized polarizing plate, a condensing lens for converting the incident light into parallel light, a polarizer holder, and an additional movement controller. An incident light must be converted into a parallel light in order to obtain the polarization effect disclosed in the above patent. To this end, a large mirror and various optical systems must be disposed on an optical path. Thus, the length of the optical path will increases, and the optical path of about 6 m or more is required in order to uniformly irradiate UV light onto a glass corresponding to the area of a third or more generation LCD. Thus, the problems are that the distance between the light source and the irradiated target surface is increased, the illumination is decreased, and the size of an irradiation device is increased.

Korean Patent No. 558161 relates to a reflective polarizing film which has improved luminance and minimized light loss and can be easily fabricated, and a display device having the same. The above reflective polarizing film has a stacked structure of a plurality of optical layers formed of photo-curable polymer material with isotropic properties, where a prism optical pattern having an apex angle between 80 to 100° (degrees) is formed in each bordering surface of the respective optical layers.

In order to overcome the problem of low luminance characteristics of polarizing films used in LCD displays in the related art, Korean Patent No. 558161 provides a reflective polarizing film capable of attaining polarized light through the Brewster polarizing effect and enhancing the amount of polarized light, which is finally emitted from the reflective polarizing film by means of re-transmission of light through an upper film located in a proceeding direction of light that is reflected on the boundary of stacked films, and an LCD device using the reflective polarizing film.

However, the above patent does not disclose how to obtain polarized light using an unparallel light source, the increase of illumination, and polarization using a scanning method. Also, the film used in the above patent will burn within a short time when exposed to a strong light source, which leads to the loss in polarizing characteristics.

Japanese Patent Laid-open No. 2000-171676 provides a large area polarizing plate securing uniformity in illuminance distribution, and comprises a quartz substrate part formed by laminating one or more square, triangular or parallelogrammatical quartz substrates that polarizes incident light, and a polarizer holder holding the quartz substrate part.

Japanese Patent Laid-open No. 1999-202335 provides a polarizing method including: disposing a plurality of transmitting plates at predetermined distances apart from each other, making light incident on a side of one of the transmitting plates with Brewster's angle, and obtaining polarized light by passing light through the transmitting plates in order to obtain a sufficiently high polarization over even a wide area.

However, in order to obtain polarized light over a wide area, polarizers provided in the related art patent disclosures are formed by stacking substrates in a triangular or parallelogrammatical form so that polarizing plates can form a Brewster's angle with respect to incident light, and require the incidence of a parallel light source onto a substrate to be polarized. Thus, technology for obtaining polarized light over a wide area with an unparallel light source is required.

Furthermore, because a Brewster polarizing plate employing a parallel light source is generally used, polarized light can be obtained through forming Brewster's angle with respect to a parallel light source by stacking quartz glass in a Brewster polarizing plate. However, in order to convert light from a point light source to parallel light source, an expensive optical system is required, and it is difficult to be applicable to the large area.

### DISCLOSURE OF INVENTION

### Technical Problem

An aspect of the present invention provides a polarizing plate for solving the problems of conventional Brewster polarizers and capable of obtaining polarized light from an unparallel light source.

Another aspect of the present invention also provides a polarizing plate capable of realizing polarized light with high illumination.

Still anther aspect of the present invention also provides a polarizing plate capable of providing superior polarized light over a wide area.

Still anther aspect of the present invention also provides a polarizing device capable of obtaining polarized light from an unparallel light source.

Still anther aspect of the present invention also provides a polarizing device capable of obtaining polarized light with high illumination.

Yet anther aspect of the present invention also provides a polarizing device capable of providing superior polarized light over a wide area.

### Technical Solution

According to an aspect of the present invention, there is provided a polarizing plate comprising a quartz substrate comprising a light incidence portion continuously formed along a direction of the quartz substrate, the light incidence portion having a triangular section, the triangular section forming a sloped angle(s) of one sloped surface or two symmetrical sloped surfaces with a real value in a range of Brewster's angle±30° (degrees).

According to another aspect of the present invention, there is provided a polarizing device including: a substrate; a light source including an ultraviolet reflective part; and a polarizing plate disposed between the substrate and the light source.

The details of one or more embodiments are set forth in the accompanying drawings and the description below. Other features will be apparent from the description and drawings, and from the claims.

### Advantageous Effects

A highly polarized ultraviolet light with a ratio of 1:30 or higher of unpolarized light to polarized light can be obtained from an unparallel light source by using a polarizing device including a polarizing plate in an embodiment of the present invention. Because a polarizing plate according to an embodiment of the present invention can obtain high polarized light even with an unparallel light source, a separate optical system for making light parallel is not required, so that the light source and polarizing plate can be positioned in proximity, and polarized light of high illumination can be obtained. Also, a polarizing plate according to an embodiment of the present invention can be used for polarizing light over a wide area.

### BRIEF DESCRIPTION OF THE DRAWINGS

FIG. 1 is a view illustrating the concept of parallel incident light being polarized, according to the related art.

FIG. 2 is a view illustrating the concept of unparallel incident light with an incidence angle of parallel+α(alpha) being polarized, according to an embodiment of the present invention.

FIG. 3 is a view illustrating the concept of unparallel incident light with an incidence angle of parallel−α‘(alpha)’ being polarized, according to an embodiment of the present invention.

FIG. 4 is a view illustrating light paths of incident light being polarized according to an embodiment of the present invention, where (a) represents unpolarized light that is parallelly incident and (b) represents unpolarized light that is unparallelly incident.

FIGS. 5A and 5B are perspective views of polarizing plates according to embodiments of the present invention.

FIG. 6 is a side cross-sectional view of a polarizing plate formed of a quartz substrate with a light incidence portion formed with a sloped surface having a sloped angle, according to an embodiment of the present invention.

FIG. 7 is a side cross-sectional view of a polarizing plate formed of a quartz substrate with a light incidence portion having two symmetrical sloped surfaces, according to an embodiment of the present invention.

FIG. 8 is a side cross-sectional view of a multilayer polarizing plate formed of stacked quartz substrates with a light incidence portion with a sloped surface having a sloped angle, according to an embodiment of the present invention.

FIG. 9 is a side cross-sectional view of a multilayer polarizing plate formed of stacked quartz substrates with a light incidence portion having two symmetrical sloped surfaces, according to an embodiment of the present invention.

FIG. 10 is a view illustrating the concept how unparallel incident light is polarized in a polarizing plate formed of stacked quartz substrates, according to an embodiment of the present invention.

FIG. 11 is a side cross-sectional view of a multilayer polarizing plate formed of stacked quartz substrates with a light incidence portion with sloped surfaces sloped in opposite directions, according to an embodiment of the present invention.

FIG. 12 is a side cross-sectional view of a multilayer polarizing plate formed of stacked quartz substrates with a light incidence portion with sloped surfaces having different sloped angles, according to an embodiment of the present invention.

FIG. 13 is a side cross-sectional view of a multilayer polarizing plate formed of stacked quartz substrates with a light incidence portion with symmetrical sloped surfaces having different sloped angles, according to an embodiment of the present invention.

FIG. 14 is a side cross-sectional view of a multilayer polarizing plate formed of stacked quartz substrates with a light incidence portion with single sloped surface having different sloped angles and directions; and double sloped surfaces having different sloped angles, according to an embodiment of the present invention.

FIG. 15 is a view of a polarizing device configured to include a polarizing plate, according to an embodiment of the present invention.

FIG. 16 is a view of a light source that can be used in a polarizing device according to an embodiment of the present invention.

FIG. 17 is a view of polarizing devices provided in plurality, according to an embodiment of the present invention.

FIG. 18 is a view illustrating a process for supplying polarized light to a large-sized base substrate through a scanning method by using a polarizing device, according to an embodiment of the present invention.

FIG. 19 is a view illustrating a configuration of stacked quartz substrates, according to a first comparative embodiment of the present invention.

FIG. 20 is a graph illustrating the polarized degree of light according to the number of stacked substrates when a Brewster's angle is formed with sloped angles of quartz substrates with respect to incident light, according to a comparative example 1.

FIG. 21 is a graph illustrating the polarized degree of light according to the number of stacked substrates when a Brewster's angle is not formed with sloped angles of quartz substrates with respect to incident light, according to a comparative example 1.

FIG. 22 is a graph illustrating the polarized degree of light according to the number of stacked substrates of a polarizing plate, according to an example 1 of the present invention.

### BEST MODE FOR CARRYING OUT THE INVENTION

Reference will now be made in detail to the embodiments of the present invention, examples of which are illustrated in the accompanying drawings.

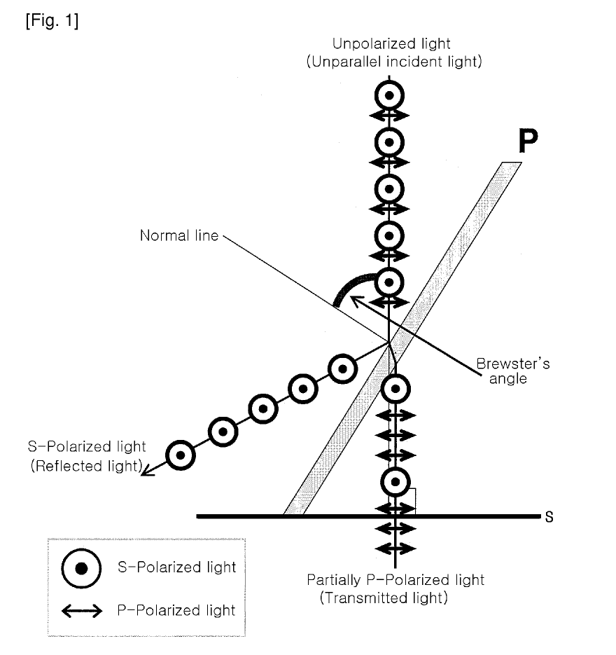

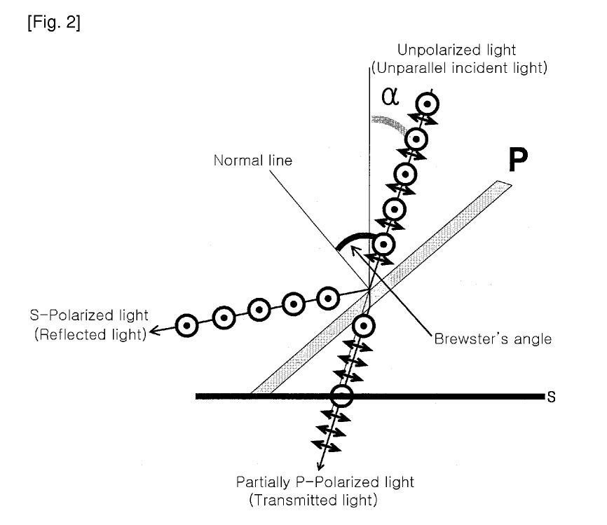

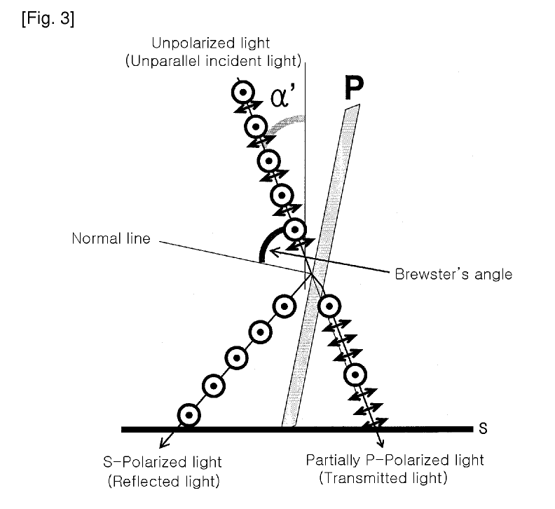

Referring to FIG. 1, in order to obtain polarized light with high P-polarized light components from unpolarized light in a conventional polarizing plate, the unpolarized light is incident on the polarizing plate to form Brewster's angle. However, as illustrated in FIGS. 2 and 3, when unpolarized incident light on the polarizing plate is unparallel light in a sloped angle range of between α(alpha) and α‘(alpha)’ with respect to Brewster's angle, if the polarizing plate (P) is tilted as much as the angular range of between α(alpha) and α‘(alpha)’, reflected light and transmitted light can still have high polarization through the effect of Brewster's angle. Accordingly, the present invention is technically characterized in that a quartz substrate, which composes of polarized plate according to an embodiment of the present invention conformingly forms a pyramid-shaped sloped portion in the light incidence portion (I) of the polarizing plate to efficiently polarize unparallel unpolarized light. That is, by forming the sloped portion in the light incidence portion (I) of the polarizing plate, the same effect is achieved as tilting the polarizing plate with respect to unparallel incident light that does not form Brewster's angle with respect to incident light on the polarizing plate.

In order to solve the related art problem of the need for light to be completely parallelly incident to obtain effective linearly or partially polarized UV light, A polarizing plate using Brewster's angle in an embodiment of the present invention uses a quartz substrate having a uneven (concavo-concave) pyramid-type structure with at least one sloped angle having a real value in a range of Brewster's angle±30° (degrees), to thus provide a polarizing plate capable of polarizing light from an unparallel light source in high illumination.

While in the related art, the light source and the polarizing plate are disposed far apart from each other in order to obtain parallel incident light to meet the 100% parallel light requirement, the distance between the light source and the polarizing plate can be shortened to substantially increase illumination of polarized light and reduce the size of the polarizing device because a completely parallel light source (a 100% parallel light source) is not required in the present invention. Moreover, a separate optical system for making light parallel is not required, and polarized light of high illumination can be provided over a large area.

That is, a quartz plate according to an embodiment of the present invention has a triangular section extending in one direction to form a light incidence portion (I), and the sloped angle of one sloped surface or of two symmetrical sloped surfaces of the triangular section may have a real value in a range of Brewster's angle±30° (degree), preferably Brewster's angle±20° (degree), and more preferably Brewster's angle±15° (degree). According to an embodiment of the present invention, the sloped angle of the sloped surface in the quartz substrate constituting the polarizing plate is associated with an angle of incident light that is out of the range in which light is parallelly incident. Therefore, even when unparallel incident light is introduced into the polarizing plate, the sloped angle of the sloped surface is formed to have a real value in a range of Brewster's angle±30° (degree) in order to have a polarizing effect by forming Brewster's angle with respect to the polarizing plate when passing through the polarizing plate. If a range of the sloped angle of the light incidence portion (I) of the quartz substrate in an embodiment of the present invention are out of the range of Brewster's angle±30° (degree), unparallel incident light cannot be polarized sufficiently to fulfill the 1:30 or more ratio of unpolarized light:polarized light in embodiments of the present invention. By forming a polarizing plate with a quartz substrate in the above embodiment of the present invention, a 1:30 or more ratio of unpolarized light to polarized light components can fulfilled.

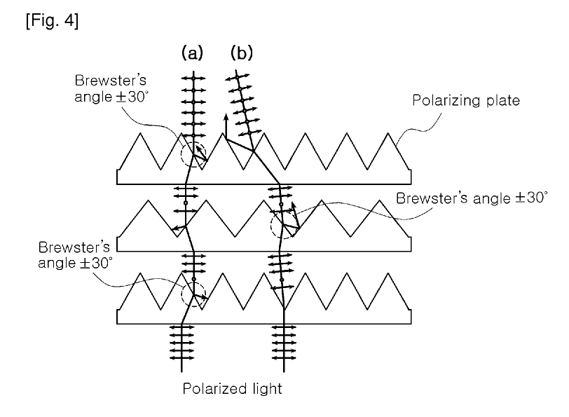

According to an embodiment of the present invention, FIG. 4 illustrates a light path emitting P-polarized light when unpolarized light is incident on a polarizing plate, which includes three layers of quartz substrates formed with two symmetrical sloped surfaces having sloped angles with a real value in a range of Brewster's angle±30° (degree). In FIG. 4, (a) represents a polarized light path for parallel incident light, and (b) represents a polarized light path for unparallel incident light. Referring to FIG. 4(a) and FIG. 4(b), when not only parallel light but unparallel light are incident on the polarizing plate and pass through the polarizing plate according to an embodiment of the present invention, P-polarized components are increased to yield a greater polarization of light. Likewise, the polarizing plate in one embodiment of the present invention is effective at polarizing unparallel and unpolarized light. The terms ‘unparallel light source’, ‘unparallel incident light,’ and ‘unparallel,’ etc. used in the specification refer to any light source which is not complete, i.e. 100% parallel light source. Therefore, they refer to parallelness within a ±30° (degree) range, preferably, within a ±20° (degree) range, and more preferably, within a ±15° (degree) range but the present invention is not particularly limited thereto. Also, the term ‘parallel’ in the expressions ‘parallel light source,’ ‘parallel light,’ etc. used in the specification refers to that lights is parallelly incident with respect to each other. The term ‘unparallel’ in the expression ‘unparallel light source,’ for example, refer to that traveling directions of lights are not parallel to each other, i.e. different in direction with a predetermined angle as in the point light source.

While incident light must be incident parallel to a substrate (S) to supply polarized light to a conventional polarizing plate using the Brewster's angle principle, a polarizing plate according to an embodiment of the present invention obtains good polarized light in response to any unparallel incident light. However, it is desirable that the incident light is unparallel within a range of parallel±30° (degree) in the aspect of the efficient use of light and the manufacture of quartz substrate with a sloped surface having a sloped angle according to embodiments of the present invention. That is, if the angle range of the parallel incident light exceeds an angle of ±30° (degrees), light is incident while being excessively diffused, which leads to the very poor efficiency in the use of the light. Also, if the angle range of the parallel incident light exceeds an angle of ±30° (degree), various quartz substrates, which not only have a slope angle exceeding the ±30° (degree) range so that the polarizing plate can form Brewster's angle with respect to incident light but also have slope angles within Brewster's angle range±30° (degree), must be manufactured, but this is inefficient.

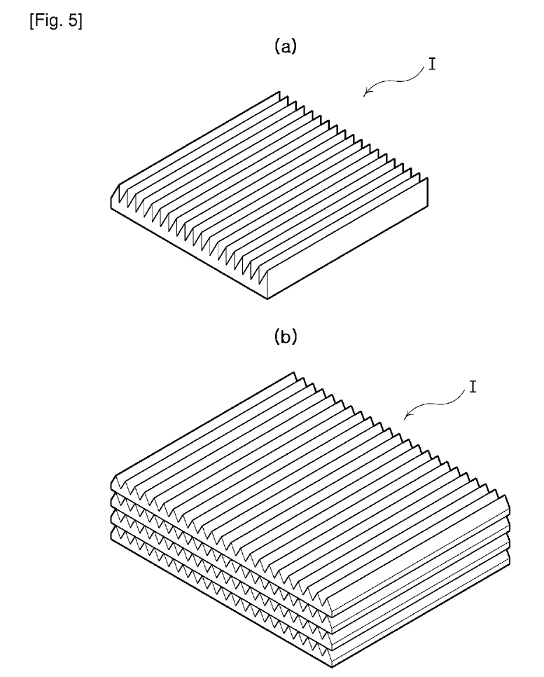

The above polarizing plate according to an embodiment of the present invention that polarizes unparallel and unpolarized light into a highly polarized state has triangular sectional light incidence portions continuously formed therein, the light incidence portions having a triangular section and extending in one direction, and perspective views of this polarizing plate according to embodiments of the present invention is illustrated respectively in FIGS. 5A and 5B. FIG. 5A depicts a polarizing plate formed of a single quartz substrate, and FIG. 5B depicts a polarizing plate formed of a plurality of stacked quartz substrates. The triangular section has one sloped surface or two symmetrical sloped surfaces formed in the light incidence portions of the quarts substrates, so that the triangular section can have sloped angles having a real value in a range of Brewster's angle±30° (degrees), preferably Brewster's angle±20° (degrees), and more preferably Brewster's angle±15° (degrees).

The thickness (d) of the quartz substrate may be approximately 1 mm (millimeter) or greater, and may preferably be between 1 mm (millimeters) and 5 mm(millimeters). If the thickness of the quartz substrate is less than 1 mm, the quartz substrate can easily be damaged during its processing or use. If the thickness of the quartz substrate exceeds 5 mm (millimeters), there is no problem with polarizing characteristics, but there are no particular advantages derived from an increasing thickness of the quartz substrate, and light transmittance would be reduced, and the distance from the light source to the substrate would increase in terms of equipment configuration. The quartz substrate forming the light incidence portion having the sloped angle may be manufactured through molding, grinding, or etching. When the uneven(concavo-concave) pattern having the sloped angles of the quartz substrate formed in the light incidence portion is formed through molding, the regular uneven pattern that is systematically recessed in the surface of the quartz substrate is formed by pouring melted quartz glass into a metal mold, cooling the mold slowly to the room temperature and then removing a molded quartz substrate from the metal mold. With grinding, the quartz substrate is ground to form the uneven pattern; however, the surface of a quartz substrate becomes opaque when ground, but this problem may be overcome with an additional polishing process. This problem does not occur with molding. With etching, a substrate having uneven pattern with an desired sloped angle is obtained in the sequential process of patterning the surface of quartz substrate with photoresist, etching pattern-free portions with hydrofluoric acid that can dissolve quartz material, and removing the photoresist.

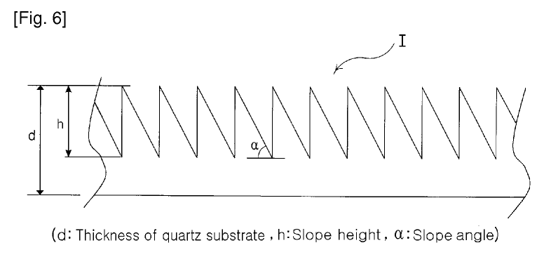

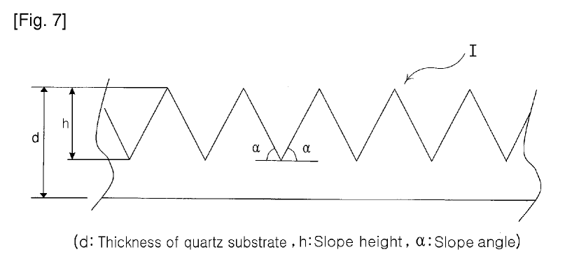

FIG. 6 illustrates a quartz substrate formed with a light incidence portion having a sloped surface with a sloped angle (α)(alpha) of Brewster's angle±30° (degrees), and FIG. 7 illustrates a quartz substrate formed with a light incidence portion having two symmetrical sloped surfaces with sloped angles (α)(alpha) of Brewster's angle±30° (degrees). The height (h) of a light incidence portion formed on the quartz substrate may be suitably adjusted, when necessary, in terms of the desired degree of polarization, etc., but the present invention is not particularly limited thereto.

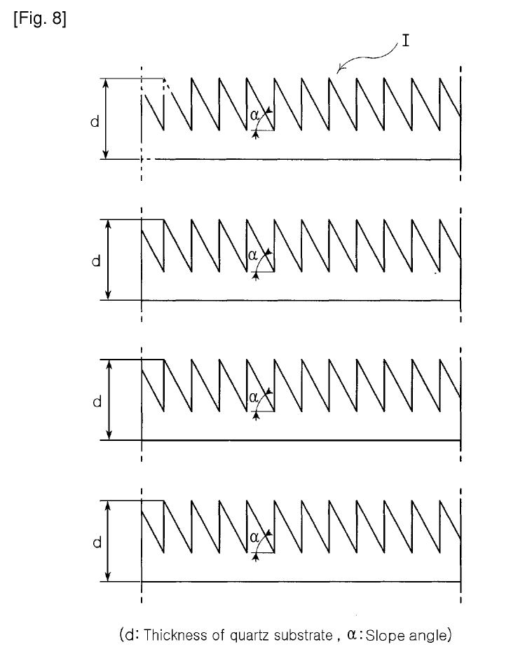

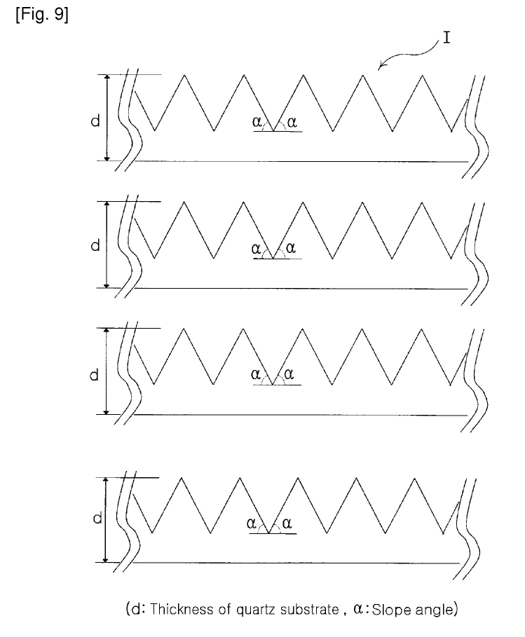

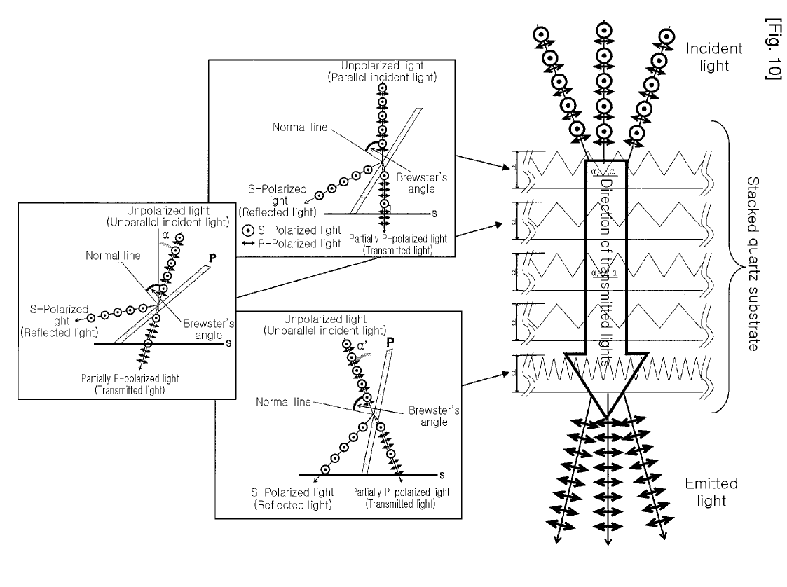

In order to maximize a desired polarization of polarized light, the polarizing plate according to an embodiment of the present invention may have a plurality of stacked quartz substrates, with light incidence portions having one sloped surface or two symmetrically sloped surfaces having a sloped angle(s) having a real value in a range of Brewster's angle±30° (degrees) range. That is, as a non-limiting example, a polarizing plate according to an embodiment of the present invention may be formed of a plurality of stacked quartz substrates having a light incidence portion with one sloped surface having a sloped angle (α)(alpha) as illustrated in FIG. 8, or be formed of a plurality of stacked quartz substrates having two symmetrically sloped surfaces with sloped angles (α)(alpha) as illustrated in FIG. 9, but the present invention is not particularly limited thereto. Accordingly, by using a plurality of stacked quartz plates formed with a light incidence portion having a sloped angle with a real value in a range of Brewster's angle±30° (degrees), an improved polarizing effect for unparallel light can be obtained. That is, in other embodiments of the present invention, when quartz substrates having the same or different sloped angles are stacked in a multiple layer form, the quartz substrates approximately form Brewster's angle with respect to unparallel and unpolarized incident light when the unparallel and unpolarized incident light passes through the polarizing plate. Therefore, light that passes through the polarizing plate is ultimately emitted as P-polarized light. FIG. 10 illustrates this concept according to the present invention.

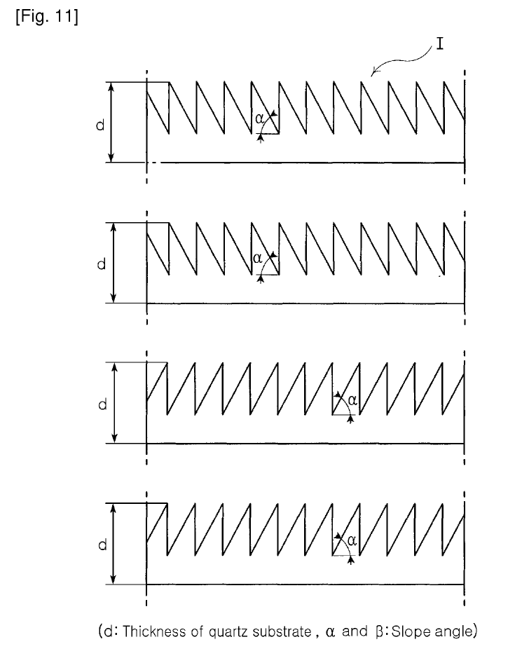

In a quartz substrate having one sloped surface, the polarizing plate may be configured with quartz substrates stacked in opposite sloped directions, which is illustrated in FIG. 11.

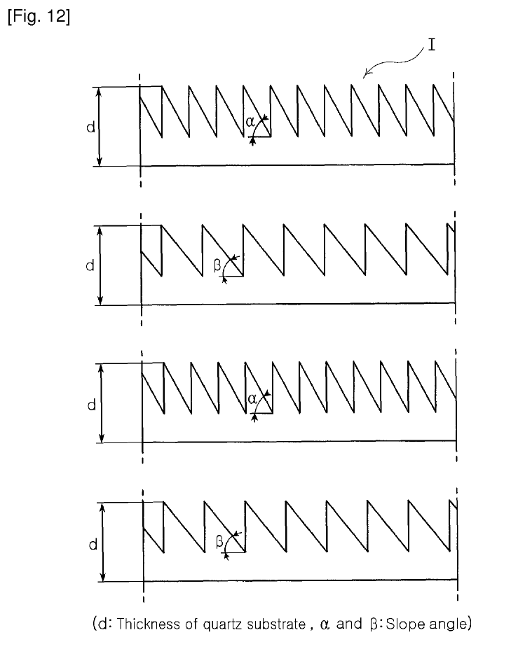

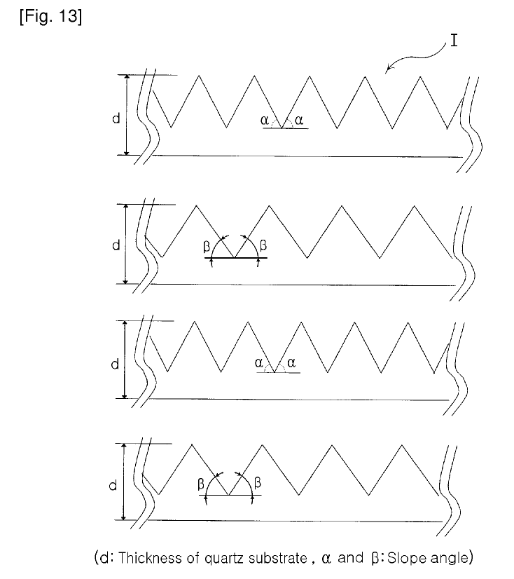

Further, a polarizing plate according to an embodiment of the present invention may be formed of a plurality of quartz substrates formed with a light incidence portion having a sloped surface or two symmetrical sloped surfaces with respectively different sloped angles having a real value in a range of Brewster's angle±30° (degrees). In this case, the sloped angle and/or sloped direction of each quartz substrate in the stacked quartz substrates may be the same or different. FIG. 12 illustrates a polarizing plate of stacked quartz substrates forming a light incidence portion having one sloped surface with different sloped angles of α(alpha) and β(beta) and FIG. 13 illustrates a polarizing plate of stacked quartz substrates forming a light incidence portion having two symmetrically sloped surfaces with different sloped angles of α(alpha) and β(beta).

The number of stacked quartz substrates formed with a light incidence portion having a sloped surface and/or two symmetrical sloped surfaces with a sloped angle of Brewster's angle±30° (degrees); the sloped angle, sloped direction, and sloped shape of the respective light incidence portions; and the stacking sequence, thickness of the quartz substrates, etc. may be suitably selected and applied to satisfy required polarization degree of light according to above objects of the present invention and particularly, to objects of the present invention, while not specifically stated herein, that will become apparent from the entirety of this disclosure, and will not be restricted by any specific embodiment of a polarizing plate provided herein, in terms of sloped direction, sloped angle, sloped shape, or stacked sequence of the quartz substrates, etc.

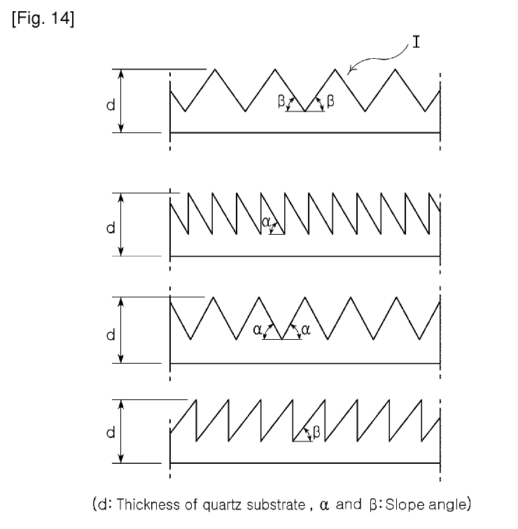

As a configurative embodiment of the present invention, FIG. 14 illustrates a polarizing plate of stacked quartz substrates forming light incidence portions having different sloped angles, sloped direction and one sloped surface or two sloped surfaces.

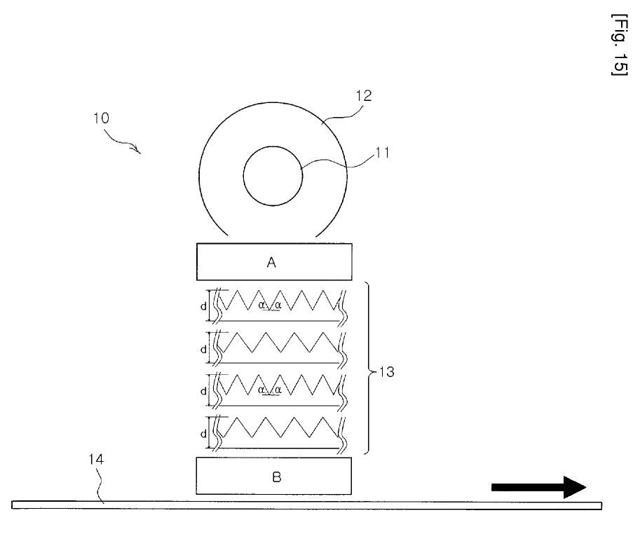

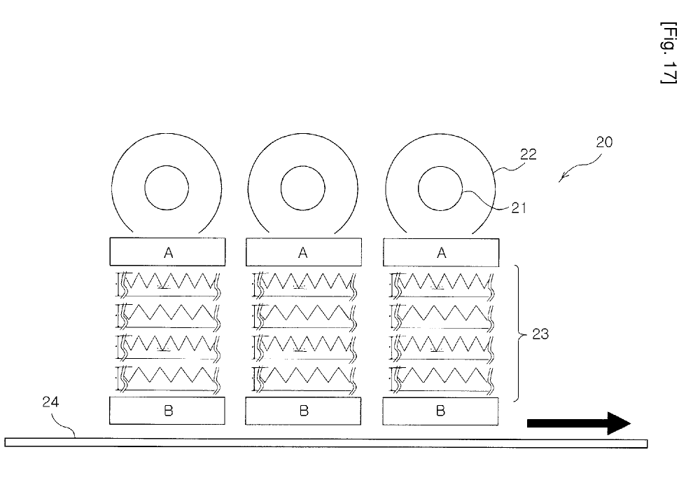

According to another embodiment of the present invention, a polarizing devices 10 and 20 comprising a substrates 14 and 24, light sources 11 and 21 comprising an ultraviolet reflective parts 12 and 22, and the polarizing plates 13 and 23 according to an embodiment of the present invention disposed between the substrates and the light sources are provided. The polarizing devices 10 and 20 according to an embodiment of the present invention are illustrated in FIGS. 15 and 17.

While the distance between a light source and a polarizing plate in a conventional polarizing device requiring a parallel light source is 6 m (meters) or greater, a polarizing device 10 and 20 according to an embodiment of the present invention exhibits a high polarization even with an unparallel light source, so that the distance between a light source 11 and 21 and a polarizing plate 13 and 23 in the polarizing device can be disposed in a shorter range than the conventional polarizing device. Accordingly, the polarizing device can be considerably reduced in size. Specifically, the closer the distance between the light source and the polarizing plate is, the more the polarizing device is reduced in size and the greater the illumination is. Therefore, it is more preferred to make the distance between the light source and the polarizing plate closer, and a distance of between the light source and the polarizing plate may be 15 cm (centimeters) or less, but the present invention is not particularly limited thereto. That is, the desired degree of polarization can be obtained within the distance between the light source and the polarizing plate, i.e. light path of 15 cm (centimeters) or less, preferably, 7 cm (centimeters) or less.

The light source used in an embodiment of the present invention may be a light source widely used in the art, and may be, for example, an unparallel, single color light source. The light source used may be a sodium light source with a D-line that is a main spectrum of 589.29 nm (nanometers), or an unparallel He—Ne laser of 632.8 nm (nanometers). A polarizing plate according to an embodiment of the present invention employs a quartz substrate that is impervious to potential damage from high intensity light sources such as those listed above. However, due to other wavelengths of light other than the main spectrum being emitted from these light sources, a color filter that transmits specific wavelengths or an interference filter may be used to remove the other spectrums of emitted light.

Moreover, while there is no particular limitation on the light sources, but an arc lamp light source, or more particularly, an arc lamp light source having a length of 1 m (meter) or more may be used. There is no particular limitation on the length of the arc lamp light source, and an arc lamp light source of any length in a current technology level may be employed; however, a long arc lamp light source may be desirably employed because it can form polarized light by scanning a large substrate to be polarized and transmitting polarized light on the large substrate.

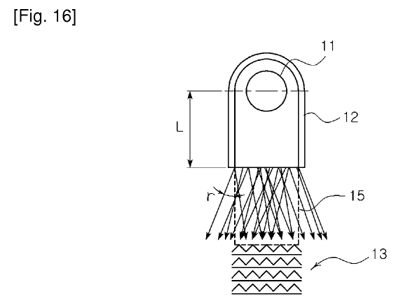

FIG. 16 is a view of a light source that can be used in a polarizing device according to an embodiment of the present invention. As illustrated in FIG. 16, a light source may have an ultraviolet reflective part 12 provided around thereof. The reflective part 12 may be formed of materials, generally known in art, that do not absorb ultraviolet light, and may employ aluminum, quartz, tempered glass, a water jacket, etc., for example, but the present invention is not limited thereto. The reflective part 12 may also have a UV reflecting coating layer formed thereon.

The UV reflective part 12 and 22 functions to converge light radiated from the light source, and may adjust the length (L) of the UV reflective part so that a light source incident on the polarizing device propagates in a somewhat parallel manner without being diffused—specifically, to enable unparallel light to be incident on the polarizing device at an unparallel margin having a real value in a range of ±30° (degrees) to parallel light, preferably, ±20° (degrees) to parallel light, and more preferably, ±15° (degrees) to parallel light. That is, the angle γ(gamma) in FIG. 16 may be ±30° (degrees).

The polarizing device 10 and 20 according to an embodiment of the present invention, may further include a filter (A) for blocking light of unnecessary wavelengths and/or an optical system (A) for reducing the divergence angle of light emitted from the light source between the light source and the polarizing plate. Furthermore, a homogenizer (B) may be included between the polarizing plate and the substrates. The substrates in the polarizing device may be any substrate to provide polarized light generally-known in the art, but the present invention is not limited thereto.

Also, the polarizing device 20 according to an embodiment of the present invention may include a substrate 24, a light source 21 provided with a UV reflective part 22, and a polarizing plate 23 according to an embodiment of the present invention disposed between the substrate 24 and the light source 21, and be configured in plurality, as shown in FIG. 17. In this case, the number of the polarizing devices may be optionally selected according to the polarization degree of light, but the present invention is not particularly limited thereto.

The polarizing device including a polarizing plate according to an embodiment of the present invention may ensure a desired linearly polarized light or partially polarized light to be provided from a unparallel light source, specifically a light source within a range of parallel light±30° (degrees) to have a high illumination and polarization degree in a photo-alignment process of an LCD.

In general, while the illumination measured at the ‘irradiated target surface’ in a typical ultraviolet polarizing device is 5-20 mW/cm² (mW/square centimeters), and in the case of a polarizing device according to an embodiment of the present invention, the illumination obtained from the irradiated target surface may be in a range of approximately 50˜more than several hundreds of mW/cm² (mW/square centimeters), although this may vary according to the intensity of light sources.

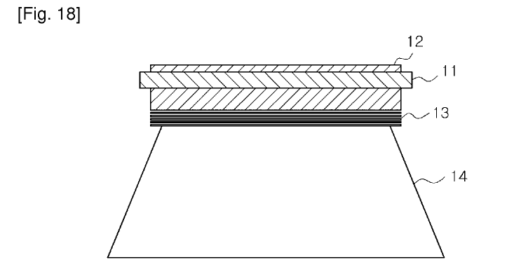

FIG. 18 illustrates a polarizing plate according to an embodiment of the present invention, which may also supply polarized light over a large base substrate. That is, unlike the conventional polarizing plate that employs a point light source, the polarizing plate of the present invention may use a long lamp as a light source. Therefore, a substrate (for example, a glass substrate, etc) to be irradiated with polarized lights may be transferred through a conveying process and simultaneously irradiated with a light source through the polarizing plate according to an embodiment of the present invention, as illustrated in FIG. 18. According to such a scanning method, a polarized light with superior polarization degree may be endowed to the substrate. The polarizing device 10 and 20 according to an embodiment of the present invention may be used in a photo-alignment process of an LCD.

Below, the configuration of an embodiment of the present invention will be described in detail in embodiments. However, the below embodiments should not be construed as limiting the present invention, and should be understood as being within modifications and alterations, and the spirit and scope of the present invention.

### MODE FOR THE INVENTION

### Comparative Example 1

Polarization degrees of light were measured in the comparative example 1 in the case of a conventional polarizing plate of the quartz substrates stacked at sloped angles when the quartz substrates form a Brewster's angle with respect to incident light (Case A) and when the quartz substrates do not form a Brewster's angle with respect to incident light (Case B). Further, the number of stacked quartz layers was varied to measure the change in the polarization degree of light according to the number of stacked quartz substrates.

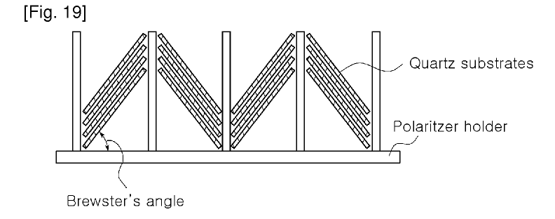

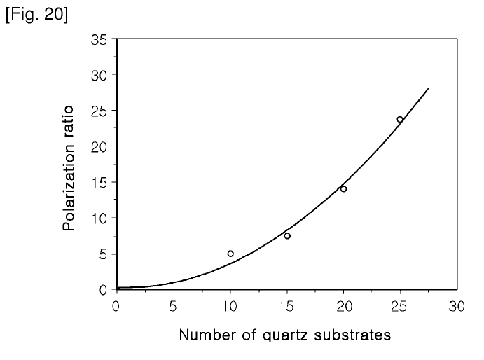

As illustrated in FIG. 19, the quartz substrate with a size of 100 mm (millimeters)×100 mm (millimeters) and a thickness of 0.7 mm (millimeters) was stacked by altering the number of the stacked substrates as in FIG. 20 to measure the polarization degree of light according to an increasing number of the stacked quartz substrates. The polarized light emitted as parallel incident light from a light source of high pressure mercury (with a light source energy of 750 W and a wavelength of 365 nm(nanometers) was irradiated at an incident angle to form Brewster's angle of 33.6°±0.5° (degrees) on the quartz substrate, and measured for polarization degree. Then, the results are illustrated in FIG. 20.

Here, the light source was provided with a hemispheric tempered glass material coated with a reflective material of aluminum thin film having a diameter of 100 mm (millimeters).

Polarization degree of light was calculated from the intensities of parallel and perpendicular lights to a light transmitted axis for Brewster's polarizer by using the following equation 1. A illumination sensor that can measure illumination of a 365 nm (nanometers) ultraviolet wavelength, and a Glen-Thomson polarizing prism that has a 10,000:1 polarization degree as measured according to the following equation 1 are used in the determination of Polarization degree of light.

P_{Polarization ratio}=Intensityₚₐᵣₐₗₗₑₗ/Intensity_{perpendicular}

where,

P_{Polarization ratio}:the polarization ratio

Intensityₚₐᵣₐₗₗₑₗ:the intensity of parallel light

Intensity_{perpendicular}:the intensity of perpendicular light. [Equation 1]

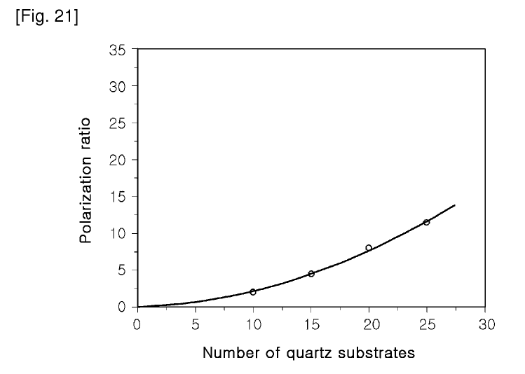

Polarization degree was measured in the same manner as described above, except that the incident light has an incidence angle of 18° (degree), which is out of the Brewster's angle range with respect to the quartz substrates. Then, the results are illustrated in FIG. 21.

As shown in FIGS. 20 and 21, it was revealed that, in both cases in FIGS. 20 and 21, while the polarization degree was increased with an increase in the number of stacked quartz substrates, in the case of FIG. 21 where the angle that the quartz substrates form with respect to incident light is out of the Brewster's angle range, the polarization degree was greatly reduced.

As seen in this comparative example, in devices designed to be used for mass production of polarized UV light in the field of LCDs or related industries up to date, parallel incident light must be incident on a polarizing plate to form Brewster's angle. However, this entails the problems regarding the need for a complex optical system or an optical equipment, high manufacturing cost, and reduced illumination caused by a long optical path between the light source and the polarized substrate.

### Example 1

A quartz substrate 1 with a size of 100 mm (millimeters)×100 mm (millimeters), a thickness of 2 mm (millimeters), a refractive index of 1.457 and a sloped angle height (h) of 0.5 mm (millimeters) was manufactured by grinding one surface of the quartz substrate to form a light incidence portion having a sloped angle of 45° (degrees), as shown in FIG. 6.

A quartz substrate 2 with a size of 100 mm (millimeters)×100 mm (millimeters), a thickness of 2 mm (millimeters), a refractive index of 1.457, and a sloped angle height (h) of 0.5 mm (millimeters) was manufactured by grinding one surface of the quartz substrate to form a light incidence portion having a sloped angle of 18° (degrees) for two symmetrical sloped surfaces, as shown in FIG. 7.

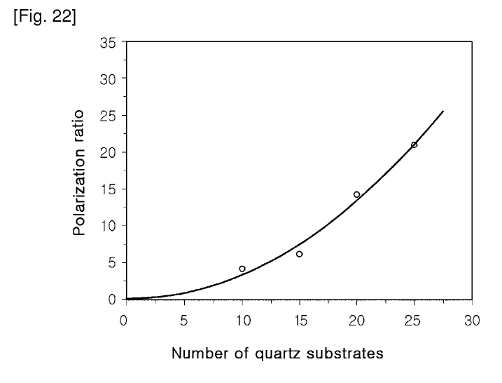

Then, the quartz substrate 1 and the quartz substrate 2 are alternately stacked to form a polarizing plate, and the polarizing plate was measured for polarization degree according to the change in the number of the stacked quartz substrates, as illustrated in FIG. 22.

Three 6 W arc lamps were provided in the upper portion of the polarizing plate manufactured in the present embodiment. In this case, each of the 6 W arc lamps has a an effective light emission length of 100 mm (millimeters) and a length of 180 mm (millimeters) and is provided with a tempered glass (materials) reflective part coated with aluminum thin film. And, polarization degree was measured by irradiating light (i.e. unparallel light within a range of parallel±25° (degrees)) of an intensity of 100 mW/cm² (mW/square centimeters) and wavelength of 365 nm (nanometer) from the upper portion of the polarizing plate and the substrate (refer to FIG. 16, γ(gamma)=±25° (degrees)). The quartz substrates and the substrate were all parallelly aligned in a horizontal direction. The substrate used was a glass substrate coated with a polyamide photo-alignment coating layer. Here, the distance between the light source and the polarizing plate was 15 cm (centimeters). This distance may be reduced or enlarged, when necessary. As in the comparative example 1, polarization degree of light was calculated from the intensities of parallel and perpendicular lights to a light transmitted axis for Brewster's polarizer by using the above equation 1. A illumination sensor that can measure illumination of a 365 nm (nanometers) ultraviolet wavelength, and a Glen-Thomson polarizing prism that has a 10,000:1 polarization degree as measured according to the above equation 1 are used in the determination of Polarization degree of light.

When polarization degrees were measured, the illumination of the light source was taken on a substrate surface 15 cm (centimeters) disposed apart from an installed polarization plate, i.e. disposed 30 cm (centimeters) apart from the light source. As shown in FIG. 22, it was revealed that the polarization degrees measured in the present example are substantially identical to those from FIG. 20 in the use of completely parallel light. In the polarizing plate including 15 stacked quartz substrates, a high illumination of 54 mW/cm² (mW/square centimeters) was obtained, measured at 254 nm (nanometers) on a substrate surface disposed 15 cm (centimeters) apart from the polarizing plate, i.e. a substrate surface disposed 30 cm (centimeters) apart from the light source.

The optical device in this example has a simple configuration as illustrated in FIG. 15, and does not require an additional separate device to obtain a parallel light source. Also, it can be considered from the example 1 that a polarizing plate and an optical device of an embodiment of the present invention do not require the high costs and a long light path that are required in the conventional method, and therefore the polarizing plate and the optical device may be manufactured more simply, and can form polarized ultraviolet light of high intensity at a low cost. The polarizing plate according to an embodiment of the present invention can be very simply applied at small volume and low cost to a moving process such as that illustrated in FIG. 18 in which a glass substrate is transferred by a conveyer. Moreover, when a higher polarization degree is required, the polarization degree may be simply increased by increasing the number of substrates to be stacked.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-22. (canceled)

23. A polarizing plate comprising a quartz substrate comprising a light incidence portion continuously formed along a direction of the quartz substrate, the light incidence portion having a triangular section, the triangular section forming a sloped angle(s) of one sloped surface or two symmetrical sloped surfaces with a real value in a range of Brewster's angle±30° (degrees).

24. The polarizing plate of claim 23, wherein the quartz substrate is stacked in plurality.

25. The polarizing plate of claim 24, wherein the respective stacked quartz substrates have the same or different sloped angle.

26. The polarizing plate of claim 24, wherein the triangular section of the light incidence portion in each of the stacked quartz substrates has one sloped surface formed in the same or different direction.

27. The polarizing plate of claim 23, wherein the sloped angle has a real value in a range of Brewster's angle±20° (degrees).

28. The polarizing plate of claim 27, wherein the sloped angle has a real value in a range of Brewster's angle±15° (degrees).

29. The polarizing plate of claim 23, wherein the polarizing plate is used to polarize unparallel incident light.

30. The polarizing plate of claim 29, wherein the unparallel light is unparallel in a range of parallel±30° (degrees).

31. The polarizing plate of claim 30, wherein the unparallel light is unparallel in a range of parallel±20° (degrees).

32. The polarizing plate of claim 31, wherein the unparallel light is unparallel in a range of parallel±15° (degrees).

33. The polarizing plate of claim 29, wherein the unparallel light is supplied from an arc lamp light source.

34. The polarizing plate of claim 33, wherein a distance between the light source and the polarizing plate is 15 cm (centimeters) or less.

35. The polarizing plate of claim 23, wherein light polarized with the polarizing plate has an illumination of 50 mW/cm² (mW/square centimeters) or greater.

36. The polarizing plate of claim 23, wherein a polarized light is irraidated to a substrate through a scanning method of irradiating a light source through the polarizing plate.

37. A polarizing device comprising:
a substrate;
a light source comprising an ultraviolet reflective part; and
a polarizing plate of claim 23, disposed between the substrate and the light source.

38. The polarizing device of claim 37, wherein the light source is an arc lamp.

39. The polarizing device of claim 37, further comprising a filter and/or an optical device for reducing a divergence angle of light emitted from the light source between the light source and the polarizing plate.

40. The polarizing device of claim 37, further comprising a homogenizer between the polarizing plate and the substrate.

41. The polarizing device of claim 37, wherein a distance of between the light source and the polarizing plate is 15 cm (centimeters) or less.

42. The polarizing device of claim 37, wherein the polarizing device is employed in a photo-alignment process of a liquid crystal display device.
